(19) United States
(12) Patent Application Publication
(10) Pub. No.: US 2007/0074024 A1
(43) Pub. Date: Mar. 29, 2007

(54) Multiple code service system and method thereof

(75) Inventors: Cheol Ho Cheong, Seoul (KR); Taek Jean Kim, Seoul (KR); Sang Yong Lee, Seoul (KR); Tack Don Han, Seoul (KR)

Correspondence Address: NIXON & VANDERHYE, PC, 901 NORTH GLEBE ROAD, 11TH FLOOR, ARLINGTON, VA, 22203, US

(73) Assignee: COLORZIP MEDIA, INC., Seoul (KR)

(21) Appl. No.: 11/490,065

(22) Filed: Jul. 21, 2006

(30) Foreign Application Priority Data
Jul. 22, 2005 (KR) 10-2005-0066965

(51) Int. Cl. H04L 9/00

(52) U.S. Cl. 713/171

(57) ABSTRACT

A multiple code service system and method thereof are provided. A tag includes first identification information, and a terminal identifies the first identification information of the tag. A service server receives the first identification information and second identification information of the terminal from the terminal, and retrieves the associated contents or service by using the received first and second identification information as key values, and provides the retrieved contents or services. Accordingly, terminals which identify the same tag are provided with different contents or services.

### CROSS-REFERENCE TO RELATED PATENT APPLICATION

This application claims the benefit of Korean Patent Application No. 10-2005-0066965, filed on Jul. 22, 2005, in the Korean Intellectual Property Office, the disclosure of which is incorporated herein in its entirety by reference.

### BACKGROUND OF THE INVENTION

1. Field of the Invention

The present invention relates to a system for providing contents or services corresponding to a tag and a method thereof, and more particularly, to a system for providing different contents or services to terminals which identify a tag.

2. Description of the Related Art

As the Internet environment and radio communication technology have developed, various types of services and contents by using tags have also developed. Particularly, a service for providing business card information, advertisement, web contents, mobile contents, or the like to a cell phone user by identifying an image code.

### SUMMARY OF THE INVENTION

The present invention provides a system and a method of providing different contents or services to terminals which identify the same tag.

The present invention also provides a computer-readable medium having embodied thereon a computer program for executing the method of providing different contents or services to terminals which identify the same tag.

See Claims for changes to Summary

According to an aspect of the present invention, there is provided a multiple code service device including: a content database classifying services by media, based on first identification information of the medium, classifying contents by the classified services corresponding to the medium, based on second identification information of a terminal, and storing the contents; an identification (ID) receiving unit receiving the first identification information included in the medium and the second identification information of the terminal which identifies the medium; and a content retrieving unit retrieving the associated services from the content database based on the first identification information, retrieving the associated contents in the retrieved services from the content database, based on the second identification information, and providing the contents.

According to another aspect of the present invention, there is provided a multiple code service device including: a medium generator generating an image code by encoding first identification information in characters, numerals, symbols, or images on a 2D plane in a physical or electromagnetic form or generating an radio frequency identification (RFID) tag in which the first identification information is stored; a terminal identifying unit setting second identification information of one or more terminals which identify a medium according to types of services in which the medium is used; and a database (DB) generator generating contents of services corresponding to the first identification information, classifying the contents of the services based on the second identification information, and storing the contents in a database.

According to another aspect of the present invention, there is provided a multiple code service method including: classifying services by tags based on first identification information of a medium, classifying contents by the classified services corresponding to the medium based on second identification information of a terminal, and storing the contents in a database; receiving the first identification information included in the medium and the second identification information of the terminal which identifies the tag; and retrieving the associated service from the content database based on the first identification information, and retrieving the associated content in the retrieved service from the content database, based on the second identification information in order to provide the associated content.

According to another aspect of the present invention, there is provided a multiple code service method including: generating first identification information as characters, numerals, symbols, or images on a 2D plane in physical or electromagnetic form or generating an RFID tag storing the first identification information; setting second identification information of one or more terminals which identify the tag according to a type of service in which the tag is used; and generating contents of the service corresponding to the first identification information, classifying the contents of the service based on the second identification information, and storing the contents in a database.

According to another aspect of the present invention, there is provided a delivery management service method using a multiple code service, including: delivering a medium having first identification information to a sender, a receiver, and a deliveryman in a delivery management service; generating contents corresponding to second, third, and fourth identification information of terminals of sender, receiver, and a deliveryman, respectively, according to the first identification information of the medium, and storing the contents; and providing contents stored according to the first identification information to the terminals according to the identification information of the terminals, when the first to fourth identification information are received from the terminals of the sender, the receiver, and the deliveryman.

According to another aspect of the present invention, there is provided a multiple code service system, including: a content database classifying services by media, based on first identification information of the medium, classifying contents by the classified services corresponding to the media, based on second identification information of a terminal, and storing the contents; a medium decoding unit decoding the first identification information of the medium; and a content retrieving unit retrieving the services corresponding to the first identification information, and the contents corresponding to the second identification information of the medium decoding unit in the retrieved services.

Accordingly, terminals which identify the same tag are provided with different contents or services.

### BRIEF DESCRIPTION OF THE DRAWINGS

The above and other features and advantages of the present invention will become more apparent by describing in detail exemplary embodiments thereof with reference to the attached drawings in which:

FIGS. 1A to 1C are views showing image codes, each of which is a type of a tag according to an embodiment of the present invention;

FIG. 2A is a view showing a structure of a multiple code service system according to an embodiment of the present invention;

FIG. 2B is a view showing a structure of a multiple code service device which is a service server according to an embodiment of the present invention;

FIG. 2C is a view showing a structure of a multiple code service device according to another embodiment of the present invention;

FIG. 3 is a view showing a data structure stored in a content database according to an embodiment of the present invention;

FIG. 4 is a flowchart showing a multiple code service method according to an embodiment of the present invention;

FIG. 5 is a flowchart showing a method of generating a content database for a multiple code service according to an embodiment of the present invention;

FIG. 6 is a view showing an example of a door security service using a multiple code service method according to an embodiment of the present invention;

FIG. 7 is a view showing an example of a delivery management service using a multiple code service method according to an embodiment of the present invention; and

FIG. 8 is a flowchart showing a multiple code service method according to another embodiment of the present invention.

### DETAILED DESCRIPTION OF THE INVENTION

Hereinafter, a multiple code service system and method thereof according to the present invention will be described in detail with reference to the accompanying drawings.

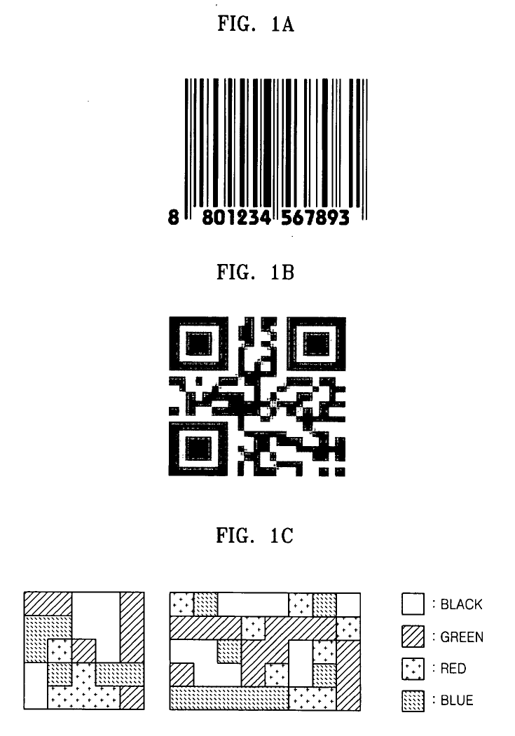

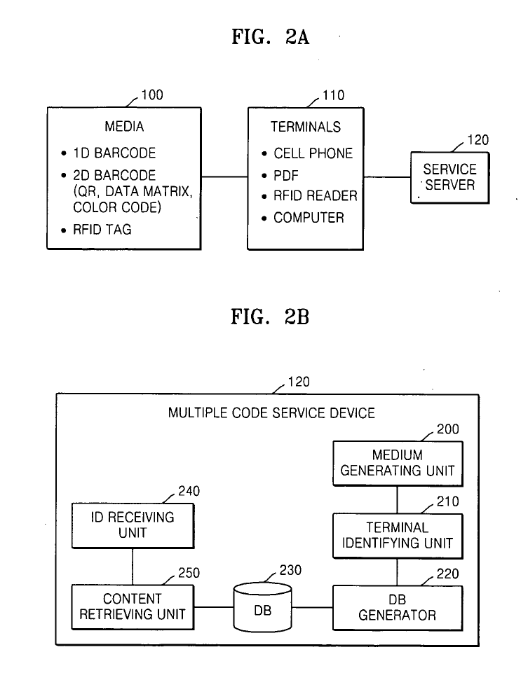

FIGS. 1A to 1C are views showing image codes, each of which is a type of tag according to an embodiment of the present invention.

The image codes are formed in the shape of an image. A barcode is generally used as the image code. Examples of the image codes include 2D barcodes based on the barcode, a QR code and a PDF-417, which are formed as a matrix type, an intercode, and a colorcode which is formed as a matrix type and uses four or more colors

The image codes are identified by optical sensors such as a charge coupled device (CCD) and printed onto paper or packing vinyl in order to be used. The image codes can be generated by using general printers. The image codes can be identified by specific devices or general-purpose devices such as web cameras.

The barcode shown in FIG. 1A is the most generally used tag interface and has been mainly used in distribution and delivery industries. The barcode, which is the interface having very high identification rate of nearly 100%, can be printed onto various media such as paper and packing paper at a low cost, and the size thereof can be reduced or enlarged. The barcode is formed by arranging black lines having different widths in different intervals on a white background, and a code value of the barcode is identified by the CCD or a laser. A European article number (EAN) system and a Universal Product Code (UPC) system are used as a barcode system.

The 1D barcode has a high decoding reliability and is a non-contact type. In addition, the barcode is simply coded and easy to write. However, the 1D barcode has problems in that, data capacity of the barcode is small, information density is low, types of information are limited, and it is difficult to decode when a symbol of the 1D barcode is contaminated or damaged. Therefore, a 2D barcode is proposed as a new information medium so as to compensate for shortcomings of the 1D barcode. As shown in FIG. 1B, the 2D barcode is generated by arranging data in two (X and Y) directions on a plane. In the 1D barcode symbology, there is a problem of a limitation to data representation, that is, a difficulty in representing a large amount of data. In order to compensate for this limitation, the 2D barcode was introduced in the middle of the 1980s.

The colorcode shown in FIG. 1C is identified by general-purpose devices such as web cameras, scanners, and camera phones. The colorcode forms a wide code area by using colors and improved design. As shown in FIG. 1C, the colorcode is a combination of cells having colors, but the cells are shown in black and white in the figure. The combination of the color cells shows a result of encoding specific information and is converted into bit information according to red (R), green (G), and blue (B) values in order to be used.

The colorcode is a next-generation code for representing various types of information in the Internet and network environments to connect various types of information in wired and wireless Internet environments. In addition, the colorcode is represented by colors, so that the colorcode is visible and is well-designed. Therefore, a user can distinctly recognize the existence of the colorcode. The colorcode includes a parity region for detecting errors and a direction detecting region for detecting a degree of rotation and directionality of the colorcode, so that positions of the cells are detected, a deformation thereof is compensated, and the errors of the colorcode are detected by using the parity region. Therefore, the colorcode has a high identification rate. In addition, the colorcode has an advantage in that, the colorcode can be decoded by general-purpose cameras and scanners.

A radio frequency identification (RFID) tag is also used as the medium used as a tag. Unlike the image codes shown in FIGS. 1A to 1C, the RFID tag uses a radio frequency to check entrance/exit, transportation, position tracking, and classification of goods or persons. The RFID system includes a reader (or an interrogator), a transponder which is generally referred as a tag, and a computing device such as a computer for processing data.

During operation of the RFID system, the tag generates a signal having specific information, and the reader identifies the signal received by an antenna and analyzes the signal, so that the tag information can be obtained. The RFID system can be classified into an active RFID system and a passive RFID system. In the active RFID system, since a power supply is installed in the tag, reading, writing, and modifying are allowed, and the active RFID system has a large memory capacity and a wide reception range. However, the active RFID system has a large size and requires high cost, and there is limitation to an operating time due to the lifetime of the tag. The passive RFID is lightweight and cheap, and has a long lifetime. However, since the tag of the passive RFID has to receive energy from the reader, a reception distance shortens, and a large amount of power has to be supplied to the reader. Most read-only tags are passive RFID tags, and 32 to 128 bit information which cannot be modified is programmed therein.

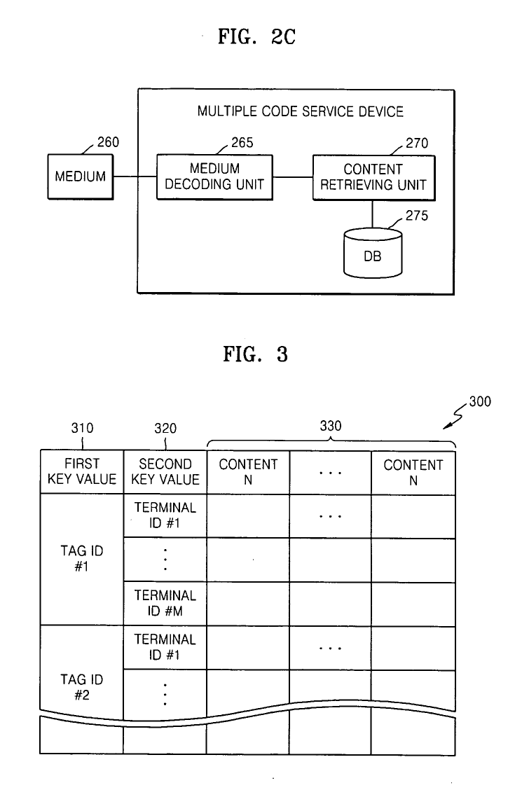

FIG. 2A is a view showing a structure of a multiple code service system according to an embodiment of the present invention.

Referring to FIG. 2A, the multiple code service system includes a medium 100 having identification information, a terminal 110 for identifying the medium 100, and a service server 120 for receiving the identification information of the medium 100 and identification information of the terminal 110 from the terminal 110 in order to provide the associated contents or services.

The medium 100 according to an embodiment of the present invention includes the identification information. When the medium 100 is one of the image codes shown in FIGS. 1A to 1C, tag information including the identification information is encoded as symbols, numerals, texts, patterns, or shadings on the image code. When the medium 100 is the RFID tag, identification information provided by a manufacturing process is used, or tag information including additional identification information is stored in the RFID tag in order to be used.

The 1D barcode shown in FIG. 1A and the RFID tag generally include only identification information thereof. However, the 2D image code shown in FIG. 1B and the colorcode shown in FIG. 1C may include additional information along with the identification information. The additional information may be texts, numerals, document information, and web address information of contents.

The terminal 110 is a device for identifying the medium 100. When the medium 100 is the image code, the terminal 110 includes an image identification device such as a CCD. When the medium 100 is the RFID tag, the terminal 110 includes an RFID reader for identifying the RFID tag. Examples of the terminals 110 for identifying the image codes may be cell phones with cameras, and computers (or notebooks) with web cameras.

The terminal 110 includes the identification information. A representative example of the identification information stored in the terminal 110 may be a cell phone number. Since the cell phone number is assigned to the cell phone, the cell phone number is automatically transmitted to the service server 120. Therefore, an additional verification process is not required. When the terminal 110 is the computing device, the identification information may be information which cannot be easily modified such as a serial number provided to each computing device, a media access control address (MAC) of a local area network (LAN), an authorization number of a central processing unit (CPU) or of a main board, or a fixed internet protocol (IP) address.

The terminal 110 employs an algorithm for decoding the identification information encoded and stored in the medium 100, and thus the terminal 110 decodes the identification information and transmits the decoded identification information to the service server 120. When the terminal 110 does not employ the code decoding algorithm, the terminal 110 transmits the raw identification information to the service server 120. When the service server 120 receives the raw identification information, the service server 120 has to include the algorithm for decoding the information.

When the medium 100 further includes address information of the service server 120 along with the identification information, and the terminal 110 employs the algorithm for decoding the information, the terminal 110 decodes the address information of the service server 120 as well as the identification information, and the terminal 110 is connected to the service server 120 by using the decoded address information.

The service server 120 is connected to the terminal 110 through wired or wireless networks in order to receive and transmit data. The service server 120 further includes a database (not shown) which stores the associated contents by using the identification information of the medium 100 and the terminal 110 as key values. The database may be included in the service server 120. Alternatively, the database may be connected to the service server 120 through wired or wireless networks. Examples of the contents stored in the database may be specific services (a door opening service, a massage delivery service, an address validation service, or the like), information such as documents, network addresses of electromagnetic files, characters, numerals, and symbols.

In a multiple code service method, the terminal 110 identifies the identification information of the medium (the image code or the RFID tag) 100, and the terminal 110 transmits the identification information of the medium 100 and the terminal 110 to the service server 120. The service server 120 then retrieves the database by using the identification information of the medium 100 and the terminal 110 as the key values to provide the associated contents (and/or services) to the terminal 110.

More specifically, the service server 120 classifies services by types by using the identification information of the medium 100 as a first key value, classifies contents or services of the classified services by using the identification information of the terminal 110 as a second key value, and stores the contents and the services in the database. Therefore, terminals 100 which identify the same medium 100 are provided with different contents or services based on the identification information of the medium 100 and the terminal 110.

FIG. 2B is a view showing a structure of a multiple code service device which is the service server 120 illustrated in FIG. 2A, according to an embodiment of the present invention.

Referring to FIG. 2B, the service server (that is, a multiple code service device) 120 includes a medium generator 200, a terminal identifying unit 210, a database (DB) generator 220, a content database 230, an identification (ID) receiving unit 240, and a content retrieving unit 250.

The medium generator 200 generates the medium (the image code or the RFID tag) having predetermined identification information according to the service type. More specifically, the medium generator 200 generates an image code by mapping tag information having the identification information in colors, shadings, patterns, and symbols or generates an electromagnetic tag by mapping the tag information as an electromagnetic signal type. The generated medium is transmitted or provided by using a physical method (printing or attaching to documents or goods, pieces, or tag chips) or by using an electromagnetic method (image files, electromagnetic displays, or the like).

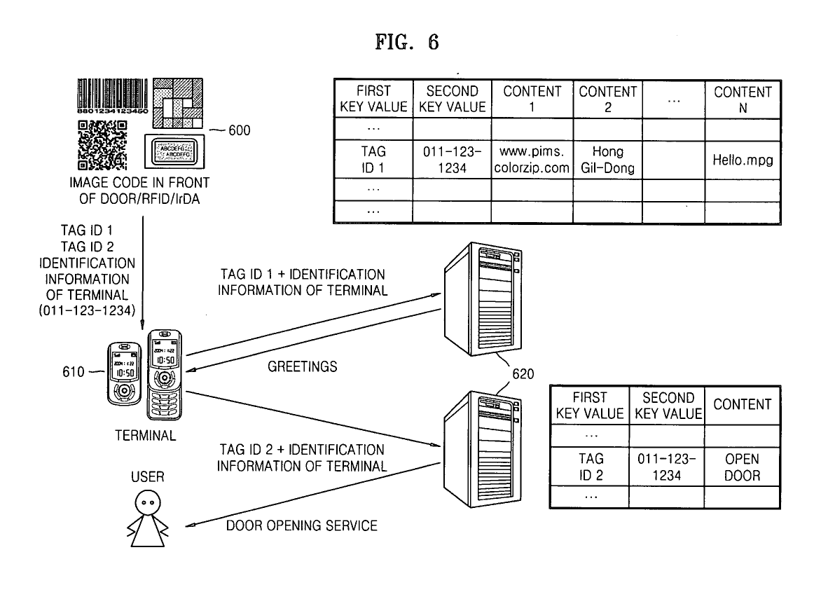

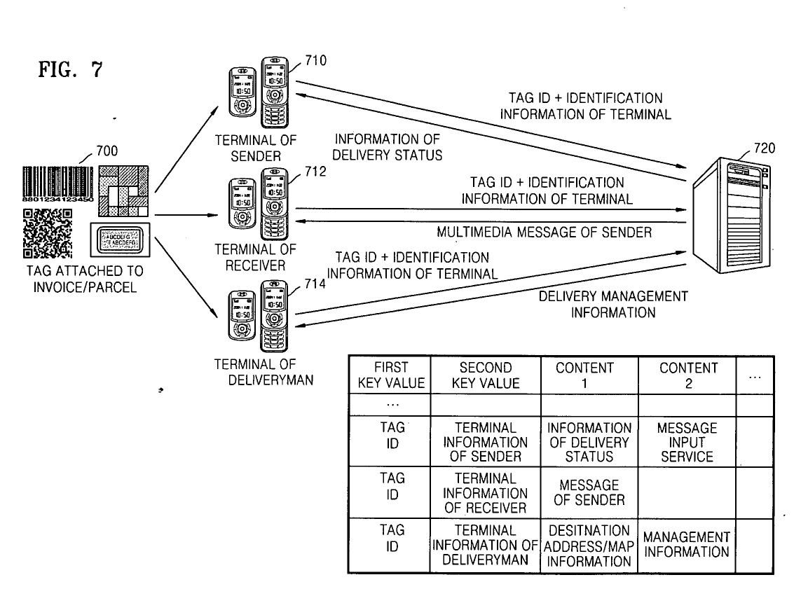

The terminal identifying unit 210 identifies the identification information of the terminal 110 of a user who uses the multiple code service according to an embodiment of the present invention. For example, when a door security service as illustrated in FIG. 6 is provided, the terminal identifying unit 210 identifies the identification information of the terminal 110 of a verified user of the door. As another example, when a delivery management service as illustrated in FIG. 7 is provided, the terminal identifying unit 210 identifies identification information of terminals 100 of sender, receiver, and deliveryman.

The DB generator 220 classifies services by type (for example, the door security service, the delivery management system, or the like) based on the identification information given to the tag, classifies contents and services of the classified services based on the identification information of the terminal 110, and stores the contents and the services in the content database 230.

As described above, when the content database 230 is generated, terminals which identify the same medium 100 can be provided with different contents or services.

More specifically, the ID receiving unit 240 receives the identification information of the medium 100 and the terminal 110 from the terminal 110. The content retrieving unit 250 retrieves the associated contents or services to be provided, from the content database 230, based on the identification information of the medium 100 and the terminal 110, received from the ID receiving unit 240.

FIG. 2C is a view showing a structure of a multiple code service device according to another embodiment of the present invention.

Referring to FIG. 2C, a multiple code service device includes a medium 260, a medium decoding unit 265, a content retrieving unit 270, and a content database 275. The medium 260 is an information recording medium having identification information such as the image code shown in FIGS. 1A to 1C or the RFID tag.

The medium decoding unit 265 is a device for identifying the medium 260. When the medium 260 is the image code, the medium decoding unit 265 includes the optical sensor such as the CCD. When the medium 260 is the RFID tag, the medium decoding unit 265 includes an RFID reader or the like. The decoding unit 265 may include at least one or more identification information. When the decoding unit 265 includes two or more pieces of identification information, a means for the user to select one of the pieces of identification information may be included therein.

The content database 275 stores contents by using the identification information of the medium 260 as a first key value and the identification information of the medium decoding unit 265 as a second key value.

The content retrieving unit 270 retrieves the services from the content database 275 based on the identification information of the medium 260. Then the content retrieving unit 270 retrieves contents from the retrieved service based on the identification information of the decoding unit 265 in order to provide the associated contents.

FIG. 3 is a view showing a data structure stored in the content database 230 according to an embodiment of the present invention.

Referring to FIG. 3, a data structure 300 of the content database 230 uses the identification information of the medium 100 as the first key value 310 and uses the identification information of the terminal 110 as the second key value, and contents or services 330 corresponding to the first and second key values 310 and 320 are stored therein.

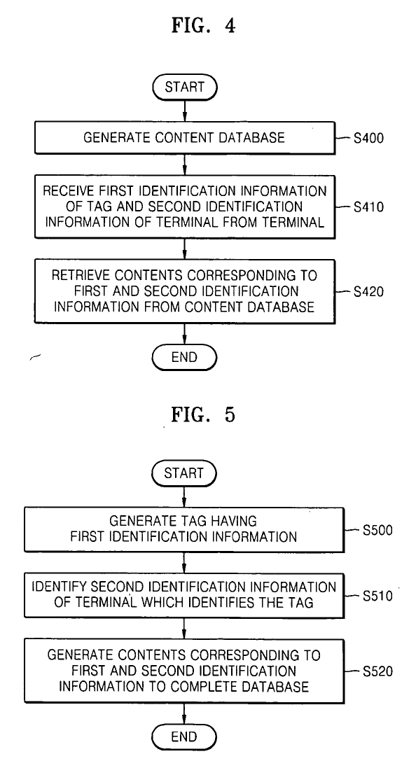

FIG. 4 is a flowchart showing a multiple code service method according to an embodiment of the present invention. FIG. 5 is a flowchart showing a method of generating a content database for a multiple code service according to an embodiment of the present invention.

Referring to FIG. 4, a content database is generated (operation S400, described in detail in FIG. 5). The content database generates predetermined contents or services by using identification information of a medium and a terminal as first and second key values, respectively, and stores the contents and services.

A service server receives the identification information of the medium and the terminal from the terminal (operation S410). The service server retrieves the contents or services to-be-provided from the content database based on the identification information of the medium and the terminal (operation S420).

Therefore, terminals which identify the same medium are provided with different contents or services.

A method of generating the content database is described with reference to FIG. 5. First, a tag having identification information is generated (operation S500). Then, identification information of a terminal which identifies the tag is identified (operation S510), and the contents or services associated with the identification information of the tag and the identification information of the terminal are generated and stored in the content database (operation S520).

Accordingly, the content database includes various service types classified based on the identification information of the tag, and the contents and services are classified based on the identification information of the terminal.

FIG. 6 is a view showing an example of a door security service using a multiple code service method according to an embodiment of the present invention.

Referring to FIG. 6, a tag (an image code or an RFID tag) 600 is attached to the front of a door. When a terminal of a user 610 (for example, a cell phone with a camera and/or an RFID tag, a smartphone, a PDA, or the like) identifies the tag 600 attached to the front of the door, identification information of the tag 600 and the terminal 610 is transmitted to a door security server 620.

The door security server 620 identifies a service type to-be-provided based on the identification information of the tag 600 received from the terminal 610. In FIG. 6, a tag (tag ID 1) which is used to provide a service for delivering a notice and information on a user and a tag (tag ID 2) which is used to provide a door opening service are shown.

First, when the tag ID 1, which is used to provide the service for delivering a notice and information on a user, is identified by the terminal 610, and identification information of the tag 600 and the terminal 610 are transmitted to the door security server 620, the door security server 620 identifies the user based on the identification information of the terminal 610 in order to display the information on the user and the notice by a screen of the door.

Next, when the tag ID 2 which is used to provide the door opening service is identified by the terminal 610, the identification information on the tag 600 and the terminal 610 are transmitted to the door security server 620, and the door security server 620 identifies whether or not the user is verified to provide the door opening service. Here, when the terminal 610 is a cell phone, the identification information of the terminal 610 may be a cell phone number.

FIG. 7 is a view showing an example of a delivery management service using a multiple code service method according to an embodiment of the present invention.

Referring to FIG. 7, in the delivery management service, when a delivery company sends goods, a sender, a receiver, and a deliveryman are provided with the same tag but having different contents.

When the sender sends goods through the delivery company, the delivery company gives the sender an invoice with the tag and receives the goods, and the delivery company attaches the same tag as that of the invoice to the goods.

When a terminal 710 of the sender identifies the tag of the invoice, the terminal 710 displays the delivery status, and a service for inputting a personal message is provided to the terminal 710.

When a terminal 714 of the deliveryman identifies the tag of the goods, delivery management information, an address of the destination, and navigation information are provided to the terminal 714.

After the receiver receives the goods, when a terminal 712 of the receiver identifies the tag of the goods, the personal message input by the sender is provided to the terminal 712.

More specifically, when the goods are sent by the delivery company, a tag having predetermined identification information is generated, identification information of the terminals 710, 712, and 714 of the sender, receiver, and the deliveryman, respectively, are identified, and a database generates the associated contents and services based on the identification information of the tag, and of the terminals 710, 712, and 714. The terminals 710, 712, and 714 which identify the same tag are provided with different contents and services.

In addition, examples of the services which may be used in the present invention are as follows:

(1) a service for attaching a code to a post card or a letter and providing a multimedia message (sound, moving picture, or the like), an e-mail, web contents, or an image to a mobile phone by using the code;

for example, a private message service for sending an invitation card or a wedding card to only limited persons;

a customer relationship management (CRM) service using an advertisement: a special sale for special customers;

(2) an electromagnetic service for members of predetermined groups such as a community group or a customer group of a company in an electromagnetic environment; and

a web publishing service for code images in a blog for transmitting a multimedia personal message or a notice to people who share information with each other when the people recognize the web publishing;

a service for publishing code images of a web company using an electromagnetic method, and providing services such as a coupon download, an invitation, and a gift certificate to selected customers whose terminals are registered when the terminals of the selected customers identify the code images.

(3) a mail merge service

a service for providing messages to customers by using code identification, wherein, information in the messages such as names, designations, phone numbers, and addresses are different from each other due to different second key values;

wherein, in a group mailing service, information which is differentiated by person, such as a name, is automatically processed by the second key value;

wherein the text of the message may be directly encoded in the tag or may be downloaded from the database.

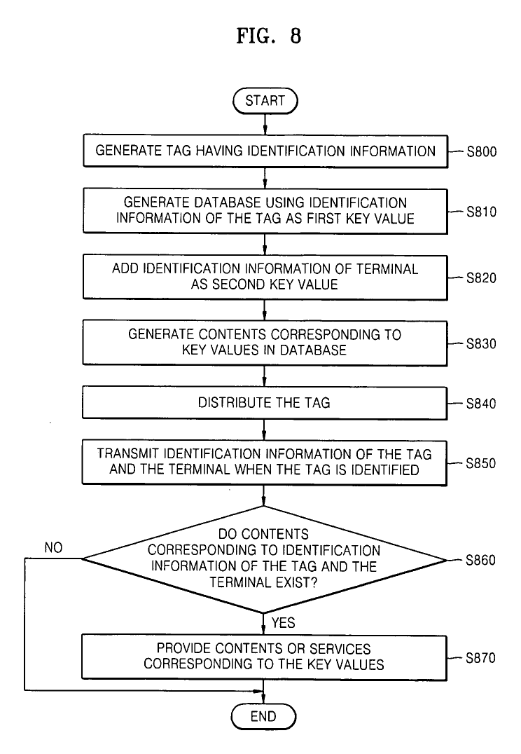

FIG. 8 is a flowchart showing a multiple code service method according to another embodiment of the present invention.

Referring to FIG. 8, a tag having identification information is generated (operation S800). A database using the identification information of the tag as a first key value is generated (operation S810), and identification information of a terminal is added to the database as a second key value (operation S820).

Next, contents and services corresponding to the first and second key values are generated and stored in the database (operation S830), and then the tag is distributed (operation S840).

When the terminal transmits the identification information of the tag and the terminal to a service server (operation S850), the service server retrieves the contents or services corresponding to the received identification information of the tag and terminal from the database (operation S860). When the associated contents and services exist, the associated contents and services are provided to the terminal (operation S870).

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

A conventional tag interface provides a single service per tag. However, in the present invention, the terminals which identify the same tag are provided with different contents or services. In addition, since services in group units can be provided, it is possible to overcome a limitation of the conventional tag interface in which a single content is provided to a tag. Therefore, the applicability of the tag is improved.

In addition, unlike the conventional tag which is publicly disclosed so that anyone can approach the content provided by the tag, in the present invention, only a verified user can be provided with the contents or services by using the identification information of the terminal, and thus there are advantages in terms of security and privacy protection.

In general, image codes can be easily copied, spread, or distributed, which means the security of the image codes is unreliable. Therefore, the conventional service uses an identification program which requires a secret code. However, in the present invention, the secret code is not required.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A multiple code service device comprising:
a content database classifying services by a medium, based on first identification information of the medium, classifying contents in the classified services corresponding to the medium, based on second identification information of a terminal, and storing the classified contents;
an ID (identification) receiving unit receiving the first identification information included in the medium and the second identification information of the terminal which identifies the medium; and
a content retrieving unit retrieving the associated services from the content database based on the first identification information, retrieving the associated contents in the retrieved services from the content database, based on the second identification information, and providing the contents to the terminal.

2. The device of claim 1, wherein the second identification information of the terminal includes any one of a cell phone number when the terminal is a cell phone, a serial number provided to a computing device, a MAC (media access control) address of an LAN (local area network), an authorization number of a CPU (central processing unit) or of a main board, and a fixed IP (internet protocol) address, when the terminal is a computing device.

3. A multiple code service device comprising:
a medium generator generating an image code by encoding first identification information in characters, numerals, symbols, or images on a 2D plane in a physical or electromagnetic form or generating an RFID (radio frequency identification) tag in which the first identification information is stored;
a terminal identifying unit setting second identification information of one or more terminals which identify a medium according to types of services in which the medium is used; and
a DB (database) generator generating contents of services corresponding to the first identification information, classifying the contents of the services based on the second identification information, and storing the contents in a database.

4. The device of claim 3, further comprising a content retrieving unit retrieving the associated content from the database based on the first and second identification information received from a predetermined terminal.

5. A multiple code service method comprising:
classifying services by a medium based on first identification information of the medium, classifying contents by the classified services corresponding to the medium based on second identification information of a terminal, and storing the contents in a database;
receiving the first identification information included in the medium and the second identification information of the terminal which identifies the medium; and
retrieving the associated service from the content database based on the first identification information, and retrieving the associated content in the retrieved service from the content database, based on the second identification information in order to provide the associated content.

6. The multiple code service method of claim 5, further comprising providing the retrieved content to the terminal.

7. A multiple code service method comprising:
generating first identification information as characters, numerals, symbols, or images on a 2D plane in physical or electromagnetic form or generating an RFID tag storing the first identification information;
setting second identification information of one or more terminals which identify the tag according to a type of service in which the tag is used; and
generating contents of the service corresponding to the first identification information, classifying the contents of the service based on the second identification information, and storing the contents in a database.

8. The multiple code service method of claim 7, further comprising retrieving the associated contents from the database according to the first and second identification information received from a predetermined terminal in order to provide the contents.

9. A delivery management service method using a multiple code service, the method comprising:
delivering a medium having first identification information to a sender, a receiver, and a deliveryman in a delivery management service;
generating contents corresponding to second, third, and fourth identification information of terminals of sender, receiver, and a deliveryman, respectively, according to the first identification information of the medium, and storing the contents; and
providing contents stored according to the first identification information to the terminals according to the identification information of the terminals, when the first to fourth identification information are received from the terminals of the sender, the receiver, and the deliveryman.

10. A multiple code service system, comprising:
a medium decoding unit decoding the first identification information of a medium; and
a content database classifying services by the medium, based on first identification information of the medium, classifying contents by the classified services corresponding to the medium, based on second identification information of the medium decoding unit, and storing the contents;
a content retrieving unit retrieving the services corresponding to the first identification information, and the contents corresponding to the second identification information of the medium decoding unit in the retrieved services.

11. The multiple code service system of claim 10, wherein the medium is an image code in which the first identification information is encoded in colors, shadings, patterns, symbols, or images on a 2D plane, or is an RFID tag having the first identification information.

12. A computer-readable medium having embodied thereon a computer program for a multiple code service method, the method comprising:
classifying services by a medium based on first identification information of the medium, classifying contents by the classified services corresponding to the medium based on second identification information of a terminal, and storing the contents in a database;
receiving the first identification information included in the medium and the second identification information of the terminal which identifies the medium; and
retrieving the associated service from the content database based on the first identification information, and retrieving the associated content in the retrieved service from the content database, based on the second identification information in order to provide the associated content.

13. A computer-readable medium having embodied thereon a computer program for a multiple code service method, the method comprising:
generating first identification information as characters, numerals, symbols, or images on a 2D plane in physical or electromagnetic form or generating an RFID tag storing the first identification information;
setting second identification information of one or more terminals which identify the tag according to a type of service in which the tag is used; and
generating contents of the service corresponding to the first identification information, classifying the contents of the service based on the second identification information, and storing the contents in a database.

14. A computer-readable medium having embodied thereon a computer program for a multiple code service method, the method comprising:
delivering a medium having first identification information to a sender, a receiver, and a deliveryman in a delivery management service;
generating contents corresponding to second, third, and fourth identification information of terminals of sender, receiver, and a deliveryman, respectively, according to the first identification information of the medium, and storing the contents; and
providing contents stored according to the first identification information to the terminals according to the identification information of the terminals, when the first to fourth identification information are received from the terminals of the sender, the receiver, and the deliveryman.
